(19) United States
(12) Patent Application Publication
(10) Pub. No.: US 2022/0069307 A1
(43) Pub. Date: Mar. 3, 2022

(54) NON-AQUEOUS ELECTROLYTE SECONDARY BATTERY

(71) Applicant: Panasonic Intellectual Property Management Co., Ltd., Osaka-shi, Osaka (JP)

(72) Inventors: Chisaki Fujitomo, Osaka (JP); Satoshi Nishitani, Osaka (JP); Junichi Sakamoto, Osaka (JP); Masaki Deguchi, Hyogo (JP)

(73) Assignee: Panasonic Intellectual Property Management Co., Ltd., Osaka-shi, Osaka (JP)

(21) Appl. No.: 17/415,062

(22) PCT Filed: Dec. 11, 2019
(86) PCT No.: PCT/JP2019/048581

§ 371 Date: Jun. 17, 2021

(30) Foreign Application Priority Data
Dec. 28, 2018 (JP) 2018-246658

(51) Int. Cl. H01M 4/58; H01M 10/0569; H01M 4/38

(52) U.S. Cl. CPC H01M 4/5825; H01M 4/386; H01M 10/0569

(57) ABSTRACT

A non-aqueous electrolyte secondary battery including a positive electrode, a negative electrode, and a non-aqueous electrolyte. The negative electrode includes a negative electrode active material capable of electrochemically absorbing and releasing lithium, the negative electrode active material includes a composite material containing a silicate phase and silicon particles dispersed in the silicate phase, and the silicate phase includes at least one of an alkali metal and an alkaline earth metal. The content of the silicon particles in the composite material is above 40 mass % and 80 mass % or less. The non-aqueous electrolyte includes a sultone compound, and the content of the sultone compound in the non-aqueous electrolyte is 2 mass % or less.

### TECHNICAL FIELD

The present invention relates to a non-aqueous electrolyte secondary battery.

### BACKGROUND ART

Non-aqueous electrolyte secondary batteries, particularly lithium ion secondary batteries, because of their high voltage and high energy density, have been expected as a promising power source for small consumer applications, power storage devices, and electric cars. With increasing demand for a higher battery energy density, a material containing silicon (Si) that forms an alloy with lithium has been expected to be utilized as a negative electrode active material having a high theoretical capacity density.

Patent Literature 1 discloses a non-aqueous electrolyte secondary battery including, as a negative electrode active material, a composite material containing a lithium silicate phase represented by Li₂ᵤSiO₂₊ᵤ (0<u<2) and silicon particles dispersed in the lithium silicate phase.

### CITATION LIST

### Patent Literature

[PTL 1] PCT Publication No. WO 2016/035290

### SUMMARY OF INVENTION

With recent development of electrical equipment with more sophisticated performance, non-aqueous electrolyte secondary batteries used for its power source are required to have a higher capacity. In the case of using the composite material as disclosed in Patent Literature 1 as a negative electrode active material, one possible way to achieve a higher capacity is to increase the silicon particle amount contained in the composite material.

When the silicon particle amount contained in the composite material is increased, however, the degree of expansion and contraction of the composite material during charge and discharge increases, and particle cracks are likely to occur in the composite material. In association with the expansion and contraction and the particle cracks of the composite material, the surface film formed on the composite material may be broken, to expose the active surface of the composite material, and the non-aqueous solvent may come in contact with the exposed surface and decompose. The decomposition of the non-aqueous solvent may lead to deterioration of the non-aqueous electrolyte, which may cause the cycle characteristics to degrade. Moreover, in association with the decomposition of the non-aqueous solvent, the amount of generated gas may be increased.

In view of the above, one aspect of the present invention relates to a non-aqueous electrolyte secondary battery, including: a positive electrode; a negative electrode; and a non-aqueous electrolyte, wherein the negative electrode includes a negative electrode active material capable of electrochemically absorbing and releasing lithium, the negative electrode active material includes a composite material containing a silicate phase and silicon particles dispersed in the silicate phase, the silicate phase includes at least one of an alkali metal and an alkaline earth metal, a content of the silicon particles in the composite material is above 40 mass % and 80 mass % or less, the non-aqueous electrolyte includes a sultone compound, and a content of the sultone compound in the non-aqueous electrolyte is 2 mass % or less.

According to the present invention, in a non-aqueous electrolyte secondary battery, a higher capacity can be achieved, and at the same time, the suppression of gas generation during battery storage and the improvement in cycle characteristics can be achieved.

### BRIEF DESCRIPTION OF DRAWING

FIG. 1 A partially cut-away schematic oblique view of a non-aqueous electrolyte secondary battery according to one embodiment of the present invention.

### DESCRIPTION OF EMBODIMENTS

A non-aqueous electrolyte secondary battery according to an embodiment of the present invention includes a positive electrode, a negative electrode, and a non-aqueous electrolyte. The negative electrode includes a negative electrode active material capable of electrochemically absorbing and releasing lithium, and the negative electrode active material includes a composite material containing a silicate phase and silicon particles dispersed in the silicate phase. The silicate phase includes at least one of an alkali metal and an alkaline earth metal. The content of the silicon particles in the composite material is above 40 mass % and 80 mass % or less. The non-aqueous electrolyte includes a sultone compound, and the content of the sultone compound in the non-aqueous electrolyte is 2 mass % or less.

In a battery including a high-capacity composite material in which the content of the silicon particles exceeds 40 mass %, by using a non-aqueous electrolyte containing a sultone compound, the increase of capacity can be achieved, and at the same time, the suppression of gas generation during battery storage and the improvement in cycle characteristics can be realized.

The sultone compound forms a surface film (SEI: Solid Electrolyte Interface) with good quality on the surface of composite material. A surface film derived from the sultone compound has excellent durability (strength) and is also excellent in followability (flexibility) to the expansion and contraction of the composite material. This can suppress the break of the surface film in association with the expansion and contraction and suppress the particle cracks of the composite material during charge and discharge.

When a sultone compound is contained in the non-aqueous electrolyte in a non-aqueous electrolyte secondary battery using a high-capacity composite material as a negative electrode active material, the durability and the followability of the surface film improve specifically. This is considered to be mainly attributed to the following factors (a) to (c).

(a) Since the silicate phase has alkalinity, the decomposition reaction of the sultone compound is facilitated at the surface of the composite material, and a dense and uniform surface film tends to be formed. (b) Since the silicate phase has alkalinity, the surface film derived from the sultone compound tends to strongly interact with the composite material (silicate phase). (c) Since the sultone compound has a relatively high reduction potential, the surface film derived from the sultone compound tends to be preferentially formed on the composite material.

As a result of suppressing the break of the surface film as described above, the exposure of the active surface the composite material can be suppressed. This can suppress the decomposition of the non-aqueous solvent due to the contact of the non-aqueous solvent with the active surface of the composite material, and thus can suppress the degradation of the cycle characteristics and suppress the gas generation in association with the decomposition of the non-aqueous solvent.

In view of forming a surface film with good quality, the non-aqueous electrolyte may contain, in addition to the sultone compound, vinylene carbonate (VC) and/or fluoroethylene carbonate (FEC) (hereinafter, VC etc.).

Typically, part of the VC etc. is utilized for the surface film formation in the initial stage, and the remaining part of the VC etc. is utilized for the restoration of the surface film which has been broken during repeated charge and discharge. In the case of using a high-capacity composite material, however, the break of the surface film due to the expansion and contraction of the composite material may be more likely to occur, to increase the amount of the VC etc. to be utilized for the restoration of the surface film, and consequently, a larger amount of gas may be generated, which may result in degradation in the cycle characteristics.

To address this, in the present invention, a sultone compound is contained in the non-aqueous electrolyte. The sultone compound has a higher reduction potential than the VC etc., and therefore, a surface film derived from the sultone compound is preferentially formed. A film derived from the VC etc. is formed mainly on the surface film derived from the sultone compound, and can function as a part of the surface film. Since the surface film derived from the sultone compound is unlikely to be broken, the surface film restoration utilizing the remaining VC etc. can be suppressed, and the gas generation associated with the surface film restoration can be suppressed, and thus, the degradation in the cycle characteristics can be suppressed.

The sultone compound is a cyclic sulfonic acid ester. The sultone compound may be a compound having a carbon-carbon unsaturated bond in its ring (hereinafter, an unsaturated sultone compound). The presence of the unsaturated bond can further improve the durability and other properties of the surface film.

The sultone compound is exemplified by a compound represented by a following general formula (1).

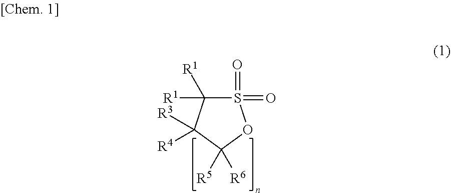

Each of R¹ to R⁶ in the general formula (1) is independently a hydrogen atom or a substituent. Examples of the substituent include a halogen atom, a hydrocarbon group, a hydroxyl group, an amino group, and an ester group.

Examples of the hydrocarbon group include an alkyl group and an alkenyl group. The alkyl group and the alkenyl group may have a straight-chain or branched-chain structure. Examples of the alkyl group include a methyl group, an ethyl group, an n-propyl group, and an isopropyl group. Examples of the alkenyl group include a vinyl group, a 1-propenyl group, and a 2-propenyl group. At least one of the hydrogen atoms in the hydrocarbon group may be substituted by a halogen atom.

In view of ensuring a favorable viscosity of the non-aqueous electrolyte and improving the dissolution, the hydrocarbon group is preferably an alkyl group having one to five carbon atoms, more preferably an alkyl group having one to three carbon atoms.

In the general formula (1), n represents the number of repeating methylene groups each having R⁵ and R⁶, and n is an integer of one to three. When n is two or three, the R⁵ and R⁶ in each methylene group may be the same as or different from each other.

Examples of the compound represented by the general formula (1) include 1,3-propane sultone (PS), 1,4-butane sultone, 1,5-pentane sultone, 2-fluoro-1,3-propane sultone, 2-fluoro-1,4-butane sultone, and 2-fluoro-1,5-pentane sultone. Preferred among them is PS because the interaction with the silicate phase is particularly strong.

Furthermore, the sultone compound is exemplified by a compound (unsaturated sultone compound) represented by a following general formula (2).

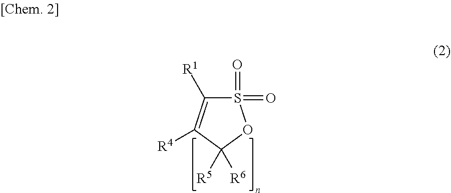

R¹, R⁴, R⁵, and R⁶, and n in the general formula (2) are similar to the R¹, R⁴, R⁵, and R⁶, and n in the general formula (1).

Examples of the compound represented by the general formula (2) include 1,3-propene sultone (PRS), 1,4-butene sultone, 1,5-pentene sultone, 2-fluoro-1,3-propene sultone, 2-fluoro-1,4-butene sultone, and 2-fluoro-1,5-pentene sultone. Preferred among them is PRS because the interaction with the silicate phase is particularly strong.

The content (mass ratio to the whole non-aqueous electrolyte) of the sultone compound in the non-aqueous electrolyte is 2 mass % or less. When the content of the sultone compound in the non-aqueous electrolyte is above 2 mass %, a surface film is formed excessively, and the reaction resistance increases, which may result in degradation in the cycle characteristics. The content of the sultone compound in the non-aqueous electrolyte can be determined by, for example, gas chromatography mass spectrometry (GCMS).

Before the first charge of the battery (or before the electrolyte injection into the battery), the content of the sultone compound in the non-aqueous electrolyte is 0.1 mass % or more and 2 mass % or less, and may be 0.2 mass % or more and 1 mass % or less. When the content of the sultone compound in the non-aqueous electrolyte is 0.1 mass % or more, a surface film derived from the sultone compound tends to be sufficiently formed.

In the process of charge and discharge of the battery, at least part of the sultone compound is reductively decomposed and utilized for the surface film formation. Accordingly, in the battery after charge and discharge (e.g., the battery in the initial stage having been subjected to several cycles of charge and discharge), the content of the sultone compound in the non-aqueous electrolyte may be below 2 mass %. When the content of the sultone compound in the non-aqueous electrolyte is 1 mass % or less at the time of preparing the non-aqueous electrolyte, for example, in the battery after the first charge, the content of the sultone compound in the non-aqueous electrolyte is, for example, 50 ppm or less. The content of the sultone compound in the electrolyte taken out from the battery may be as small as close to the detection limit. When the presence of sultone compound in the electrolyte can be identified, the action and effect according thereto can be observed.

The non-aqueous electrolyte contains a non-aqueous solvent, and a lithium salt dissolved in the non-aqueous solvent. The electrolyte preferably further contains at least one of LiN(SO₂F)₂ (hereinafter, LFSI) and LiPF₆, in terms of their wide potential window and high electric conductivity. LFSI can easily form a surface film (SEI: Solid Electrolyte Interface) with good quality on the composite material. The resistance of a surface film derived from LFSI is small, and when LFSI is used in combination with the sultone compound, a mixed surface film whose resistance is smaller than that of a surface film derived singly from the sultone compound can be formed. LiPF₆ can form a passivation film moderately on the positive electrode current collector and other components, and therefore, the corrosion of the positive electrode current collector and other components can be suppressed, leading to an improved reliability of the battery.

The concentration of the LFSI in the non-aqueous electrolyte is preferably 0.1 mol/L or more and 1.0 mol/L or less. The concentration of the LiPF₆ in the non-aqueous electrolyte is preferably 0.5 mol/L or more and 1.5 mol/L or less. The total concentration of the LFSI and the LiPF₆ in the non-aqueous electrolyte is preferably 1 mol/L or more and 2 mol/L or less. In the case of using LFSI and LiPF₆ in combination within the above concentration range, the LFSI and the LiPF₆ can exert their effects as mentioned above in a balanced manner, and the initial charge-discharge efficiency of the battery can be further enhanced.

The negative electrode active material includes at least the composite material with high capacity. By controlling the amount of the silicon particles dispersed in the silicate phase, a further higher capacity can be achieved. Since the silicon particles are dispersed in the silicate phase, the expansion and contraction of the composite material during charge and discharge can be suppressed. The composite material is therefore advantageous in achieving a higher battery capacity and improving the cycle characteristics.

The silicate phase contains at least one of an alkali metal (Group 1 element in the long-form periodic table) and an alkaline earth metal (Group 2 element in the long-form periodic table). The alkali metal includes, for example, lithium (Li), potassium (K), and sodium (Na). The alkaline earth metal includes, for example, beryllium (Be), magnesium (Mg), calcium (Ca), strontium (Sr), and barium (Ba). Particularly preferred is a lithium-containing silicate phase (hereinafter sometimes referred to as a lithium silicate phase), in terms of its small irreversible capacity and a high initial charge-discharge efficiency. In other words, preferred is a composite material containing a lithium silicate phase and silicon particles dispersed in the lithium silicate phase (hereinafter sometimes referred to as LSX or a negative electrode material LSX).

For achieving a higher capacity and improving the cycle characteristics, the content of the silicon particles in the composite material should be above 40 mass % and 80 mass % or less. When the content of the silicon particles in the composite material is 40 mass % or less, the capacity of the composite material is reduced, and the targeted initial capacity may become difficult to obtained. When the content of the silicon particles in the composite material exceeds 80 mass %, the degree of expansion and contraction of the composite material during charge and discharge may increase excessively, causing the surface film to break, which may degrade the cycle characteristics or generate a larger amount of gas.

In view of achieving a higher capacity, the content of the silicon particles in the composite material is preferably 50 mass % or more, more preferably 55 mass % or more. In this case, the lithium ions can diffuse favorably, making it easy to obtain excellent load characteristics. On the other hand, in view of improving the cycle characteristics, the content of the silicon particles in the composite material is preferably 75 mass % or less, more preferably 70 mass % or less. In this case, the exposed surface area of the silicon particles without being covered with the silicate phase decreases, and the reaction between the electrolyte and the silicon particles tends to be suppressed.

The content of the silicon particles can be measured by Si-NMR. Desirable Si-NMR measurement conditions are shown below.

Measuring apparatus: Solid nuclear magnetic resonance spectrometer (INOVA-400), available from Varian, Inc.

Probe: Varian 7 mm CPMAS-2

MAS: 4.2 kHz

MAS speed: 4 kHz

Pulse: DD (45° pulse+signal capture time 1H decoupling)

Repetition time: 1200 sec

Observation width: 100 kHz

Observation center: around—100 ppm

Signal capture time: 0.05 sec

Number of times of accumulation: 560

Sample amount: 207.6 mg

The negative electrode active material preferably further includes a carbon material that electrochemically absorbs and releases lithium ions. The composite material expands and contracts in association with charge and discharge. Therefore, increasing the ratio thereof in the negative electrode active material may cause a contact failure between the negative electrode active material particles or between the negative electrode active material and the negative electrode current collector, as the charge and discharge proceed. However, by using the composite material and a carbon material in combination, excellent cycle characteristics can be easily achieved, while a high capacity of the silicon particles can be imparted to the negative electrode.

In view of achieving a higher capacity, the ratio of the composite material to the total of the composite material and the carbon material is, for example, preferably above 0.5 mass %, more preferably 1 mass % or more, and further more preferably 2 mass % or more. In view of improving the cycle characteristics, the ratio of the composite material to the total of the composite material and the carbon material is, for example, preferably below 30 mass %, more preferably 20 mass % or less, further more preferably 15 mass % or less.

Examples of the carbon material include graphite, graphitizable carbon (soft carbon), and non-graphitizable carbon (hard carbon). Preferred among them is graphite, which is stable during charge and discharge and whose irreversible capacity is small. The graphite means a material having a graphite crystal structure, examples of which include natural graphite, artificial graphite, and graphitized mesophase carbon particles. These carbon materials may be used singly or in combination of two or more kinds.

The negative electrode may further contain another negative electrode active material, such as SiOₓ (0<x<2), in a small amount within a range that does not impair the effect of the present invention. SiOₓ contains a SiO₂ phase and silicon particles dispersed in the SiO₂ phase. On the surface of SiOₓ, too, a surface film derived from the sultone compound is possibly formed. In the case of SiOₓ, however, it is difficult to obtain a dense and uniform surface film excellent in durability as obtained in the case of the composite material, because the SiO₂ phase is neutral.

[Negative Electrode Material LSX]

The negative electrode material LSX will be described below further in details.

The silicon particles dispersed in the lithium silicate phase have a crystallite size of, for example, 10 nm or more. The silicon particles have a particulate phase of silicon (Si) simple substance. When the crystallite size of the silicon particles is 10 nm or more, the silicon particles have a small surface area, and the deterioration of the silicon particles accompanied by the generation of irreversible capacity is unlikely to occur. The crystallite size of the silicon particles can be calculated from the Scherrer formula, using a half-width of a diffraction peak attributed to the Si (111) plane of an X-ray diffractometry (XRD) pattern of the silicon particle.

The negative electrode material LSX is excellent also in structural stability. This is because the silicon particles are dispersed in the lithium silicate phase, which can suppress the expansion and contraction of the negative electrode material LSX associated with charge and discharge. In view of suppressing the cracking of the silicon particles themselves, the average particle diameter of the silicon particles before the first charge is preferably 500 nm or less, more preferably 200 nm or less, further more preferably 50 nm or less. After the first charge, the average particle diameter of the silicon particles is preferably 400 nm or less, more preferably 100 nm or less. By refining the silicon particles, the changes in volume during charge and discharge can be reduced, and the structural stability of the negative electrode material LSX can be further improved.

The average particle diameter of the silicon particles is measured by observing a cross-sectional SEM (scanning electron microscope) photograph of the negative electrode material LSX. Specifically, the average particle diameter of the silicon particles is obtained by averaging the maximum diameters of randomly selected 100 silicon particles. The silicon particle is formed of an aggregate of a plurality of crystallites.

The lithium silicate phase is an oxide phase containing lithium (Li), silicon (Si), and oxygen (O). The atomic ratio: O/Si of 0 to Si in the lithium silicate phase is, for example, above two and below four. When the O/Si is above two and below four (z in the formula below satisfies 0<z<2), it becomes advantageous in the stability and the lithium ion conductivity. The O/Si is preferably above two and below three (z in the formula below satisfies 0<z<1). The atomic ratio: Li/Si of Li to Si in the lithium silicate phase is, for example, above zero and below four. The lithium silicate phase may further contain, in addition to Li, Si, and O, a trace amount of one or more other elements, such as iron (Fe), chromium (Cr), nickel (Ni), manganese (Mn), copper (Cu), molybdenum (Mo), zinc (Zn), and aluminum (Al).

The lithium silicate phase can have a composition represented by a formula: Li_{2z}SiO_{2+z}, where 0<z<2. In view of the stability, the ease of production, and the lithium ion conductivity, z preferably satisfies 0<z<1, and more preferably z=½.

In the lithium silicate phase, there are not so many sites that can react with lithium, as compared to in the SiO₂ phase of SiOₓ. Therefore, LSX is unlikely to produce an irreversible capacity associated with charge and discharge, as compared to SiOₓ. In the case of dispersing silicon particles in the lithium silicate, excellent charge-discharge efficiency can be obtained in the initial charge and discharge. Furthermore, the content of the silicon particles can be changed as desired, which makes it possible to design a high-capacity negative electrode.

The composition of the lithium silicate phase Li_{2z}SiO_{2+z} can be analyzed, for example, by the following method.

First, the mass of a sample of the negative electrode material LSX is measured. Thereafter, the carbon, lithium, and oxygen contents in the sample are calculated as described below. Next, the carbon content is subtracted from the mass of the sample, to calculate the lithium and oxygen contents in the rest mass. The 2z and (2+z) ratios can be determined from the molar ratio of lithium (Li) to oxygen (O).

The carbon content can be measured using a carbon/sulfur analyzer (e.g., EMIA-520 available from HORIBA, Ltd.). A sample is weighed out on a magnetic board, to which an auxiliary agent is added. The sample is inserted into a combustion furnace (carrier gas: oxygen) heated to 1350° C. The amount of carbon dioxide gas generated during combustion is detected by infrared absorption spectroscopy. A calibration curve is obtained using carbon steel (carbon content: 0.49%) available from Bureau of Analysed Sampe. Ltd., from which a carbon content in the sample is determined (a high-frequency induction heating furnace combustion and infrared absorption method).

The oxygen content can be measured using an oxygen/nitrogen/hydrogen analyzer (e.g., EGMA-830, available from HORIBA, Ltd.). A sample is placed in a Ni capsule and put together with Sn pellets and Ni pellets serving as flux, into a carbon crucible heated at a power of 5.75 kW, to detect a produced carbon monoxide gas. From a calibration curve obtained using a standard sample Y₂O₃, an oxygen content in the sample is determined (an inert gas melting and non-dispersive infrared absorption method).

The lithium content can be measured as follows: a sample is completely dissolved in a heated fluoronitric acid (a heated mixed acid of hydrofluoric acid and nitric acid), followed by filtering to remove an undissolved residue, i.e., carbon, and then analyzing the obtained filtrate by inductively coupled plasma emission spectroscopy (ICP-AES). From a calibration curve obtained using a commercially available standard solution of lithium, a lithium content in the sample is determined.

Subtracting the carbon content, the oxygen content, and the lithium content from the mass of the sample of the negative electrode material LSX gives a silicon content. This silicon content involves a contribution of both silicon present in the form of silicon particles and that present in the form of lithium silicate. The content of the silicon particles can be determined by Si-NMR measurement, and this determines the content of the silicon present in the form of lithium silicate in the negative electrode material LSX.

The negative electrode material LSX is preferably formed as a particulate material having an average particle diameter of 1 to 25 μm, and more preferably, of 4 to 15 μm (hereinafter sometimes referred to as LSX particles). When the particle diameter is in the range as above, the stress caused by changes in volume of the negative electrode material LSX associated with charge and discharge can be easily reduced, and favorable cycle characteristics tend to be obtained. Also, the LSX particles tend to have a moderate surface area, and the reduction in capacity due to a side reaction with the non-aqueous electrolyte can be suppressed.

The average particle diameter of the LSX particles means a particle diameter at 50% cumulative volume (volume average particle diameter) in a particle diameter distribution measured by a laser diffraction and scattering method. For the measurement, for example, “LA-750”, available from Horiba, Ltd. (HORIBA) can be used.

The LSX particles preferably have an electrically conductive material covering at least part of their surfaces. The silicate phase is poor in electron conductivity. The electric conductivity of the LSX particles therefore also tends to be low. By covering the surface with the conductive material, the conductivity can be improved significantly. The conductive layer is preferably thin enough not to substantially influence the average particle diameter of the LSX particles.

Next, a description will be given of a non-aqueous electrolyte secondary battery according to an embodiment of the present invention. The non-aqueous electrolyte secondary battery includes, for example, a negative electrode, a positive electrode, and a non-aqueous electrolyte as described below.

[Negative Electrode]

The negative electrode includes, for example, a negative electrode current collector, and a negative electrode material mixture layer formed on a surface of the negative electrode current collector and containing a negative electrode active material. The negative electrode material mixture layer can be formed by applying a negative electrode slurry formed of a negative electrode material mixture dispersed in a dispersion medium, onto a surface of the negative electrode current collector, followed by drying. The dry applied film may be rolled, if necessary. The negative electrode material mixture layer may be formed on one surface or both surfaces of the negative electrode current collector.

The negative electrode material mixture includes, as an essential component, the aforementioned composite material (LSX etc.) serving as the negative electrode active material, and may include a binder, an electrically conductive agent, a thickener, and other optional components. The silicon particles in the composite material can absorb many lithium ions, and therefore, can contribute to increase the capacity of the negative electrode. The negative electrode material mixture may further include, as the negative electrode active material, a carbon material that electrochemically absorbs and releases lithium ions.

The ratio of the composite material to the total of the composite material and the carbon material in the negative electrode material mixture is, for example, preferably 0.5 mass % or more, more preferably 1 mass % or more, further more preferably 2 mass % or more. In view of improving the cycle characteristics, the ratio of the composite material to the total of the composite material and the carbon material in the negative electrode material mixture is, for example, preferably 30 mass % or less, more preferably 20 mass % or less, further more preferably 15 mass % or less.

Examples of the negative electrode current collector include a non-porous electrically conductive substrate (e.g., metal foil) and a porous electrically conductive substrate (e.g., mesh, net, punched sheet). The negative electrode current collector may be made of, for example, stainless steel, nickel, a nickel alloy, copper, or a copper alloy. The negative electrode current collector may have any thickness. In view of balancing between maintaining the strength and reducing the weight of the negative electrode, the thickness is preferably 1 to 50 μm, more preferably 5 to 20 μm.

The binder may be a resin material, examples of which include: fluorocarbon resin, such as polytetrafluoroethylene and polyvinylidene fluoride (PVDF); polyolefin resin, such as polyethylene and polypropylene; polyamide resin, such as aramid resin; polyimide resin, such as polyimide and polyamide-imide; acrylic resin, such as polyacrylic acid, polymethyl acrylate, and ethylene-acrylic acid copolymer; vinyl resin, such as polyacrylonitrile and polyvinyl acetate; polyvinylpyrrolidone; polyethersulfone; and a rubbery material, such as styrene-butadiene copolymer rubber (SBR). These binders may be used singly or in combination of two or more kinds.

Examples of the conductive agent include: carbons, such as acetylene black and carbon nanotubes; conductive fibers, such as carbon fibers and metal fibers; fluorinated carbon; metal powders, such as aluminum; conductive whiskers, such as zinc oxide and potassium titanate; conductive metal oxides, such as titanium oxide; and organic conductive materials, such as phenylene derivatives. These conductive agents may be used singly or in combination of two or more kinds.

Examples of the thickener include: carboxymethyl cellulose (CMC) and modified products thereof (including salts, such as Na salt); cellulose derivatives (e.g., cellulose ethers), such as methyl cellulose; saponificated products of a polymer having a vinyl acetate unit, such as polyvinyl alcohol; and polyethers (e.g., polyalkylene oxide, such as polyethylene oxide). These thickeners may be used singly or in combination of two or more kinds.

The dispersion medium is not specifically limited and is exemplified by water, alcohols such as ethanol, ethers such as tetrahydrofuran, amides such as dimethylformamide, N-methyl-2-pyrrolidone (NMP), and a mixed solvent of these.

[Positive Electrode]

The positive electrode includes, for example, a positive electrode current collector, and a positive electrode material mixture layer formed on a surface of the positive electrode current collector. The positive electrode material mixture layer can be formed by applying a positive electrode slurry formed of a positive electrode material mixture dispersed in a dispersion medium, onto a surface of the positive electrode current collector, followed by drying. The dry applied film may be rolled, if necessary. The positive electrode material mixture layer may be formed on one surface or both surfaces of the positive electrode current collector.

The positive electrode material mixture includes, as an essential component, the positive electrode active material, and may include a binder, an electrically conductive agent, and other optional components.

The positive electrode active material may be, for example, a lithium-containing composite oxide. Examples thereof include LiₐCoO₂, LiₐNiO₂, LiₐMnO₂, LiₐCobNi_{1-b}O₂, LiₐCo_{b}M_{1-b}O_{c}, LiₐNi_{1-b}M_{b}O_{c}, LiₐMn₂O₄, LiₐMn_{2-b}M_{b}O₄, LiMePO₄, and Li₂MePO₄F, where M is at least one selected from the group consisting of Na, Mg, Ca, Zn, Ga, Ge, Sn, Sc, Ti, V, Cr, Y, Zr, W, Mn, Fe, Co, Ni, Cu, Zn, Al, Cr, Pb, Sb, Bi, and B. Me includes at least a transition element (e.g., includes at least one selected from the group consisting of Mn, Fe, Co, and Ni). Here, 0≤a≤1.2, 0≤b≤0.9, 2.0≤c≤2.3. The value “a” representing the molar ratio of lithium is subjected to increase and decrease during charge and discharge.

Preferred is a lithium-nickel composite oxide represented by LiₐNi_{b}M_{1-b}O₂, where M is at least one selected from the group consisting of Mn, Co, and Al, 0≤a≤1.2, and 0.3≤b≤1. In view of achieving a higher capacity, b preferably satisfies 0.85≤b≤1. In view of the stability of the crystal structure, more preferred is LiₐNi_{b}Co_{c}Al_{d}O₂ containing Co and Al as elements represented by M, where 0<a≤1.2, 0.85≤b<1, 0<c<0.15, 0<d≤0.1, and b+c+d=1.

Examples of the binder and the conductive agent are as those exemplified for the negative electrode. Additional examples of the conductive agent include graphite, such as natural graphite and artificial graphite.

The form and the thickness of the positive electrode current collector may be respectively selected from the forms and the range corresponding to those of the negative electrode current collector. The positive electrode current collector may be made of, for example, stainless steel, aluminum, an aluminum alloy, and titanium.

[Non-Aqueous Electrolyte]

The non-aqueous electrolyte includes a non-aqueous solvent and a lithium salt dissolved in the non-aqueous solvent.

The lithium salt is contained in the non-aqueous electrolyte preferably at a concentration of, for example, 0.5 mol/L or more and 2 mol/L or less. By controlling the lithium salt concentration within the above range, a non-aqueous electrolyte having excellent ion conductivity and moderate viscosity can be obtained. The lithium salt concentration, however, is not limited to the above.

Examples of the non-aqueous solvent (main solvent) include cyclic carbonic esters (except an unsaturated cyclic carbonic ester and a cyclic carbonic ester having fluorine atom used in a later-described additive), chain carbonic esters, cyclic carboxylic acid esters, and chain carboxylic acid esters. The cyclic carbonic esters are exemplified by propylene carbonate (PC) and ethylene carbonate (EC). The chain carbonic esters are exemplified by diethyl carbonate (DEC), ethyl methyl carbonate (EMC), and dimethyl carbonate (DMC). The cyclic carboxylic acid esters are exemplified by γ-butyrolactone (GBL) and γ-valerolactone (GVL). The chain carboxylic acid esters are exemplified by methyl formate, ethyl formate, propyl formate, methyl acetate, ethyl acetate, propyl acetate, methyl propionate, ethyl propanoate, and propyl propionate. These non-aqueous solvents may be used singly or in combination of two or more kinds.

Examples of the lithium salt include: LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lithium lower aliphatic carboxylate, LiCl, LiBr, LiI, borates, and imides. Examples of the borates include lithium bis(1,2-benzenediolate(2-)-O,O′) borate, lithium bis(2,3-naphthalenediolate(2-)-O,O′) borate, lithium bis(2,2′-biphenyldiolate(2-)-O,O′) borate, lithium bis(5-fluoro-2-olate-1-benzenesulfonate-O,O′) borate. Examples of the imides include LFSI, lithium bistrifluoromethanesulfonyl imide (LiN(CF₃SO₂)₂), lithium trifluoromethanesulfonyl nonafluorobutanesulfonyl imide (LiN(CF₃SO₂)(C₄F₉SO₂)), and lithium bispentafluoroethanesulfonyl imide (LiN(C₂F₅SO₂)₂). More preferred among them is at least one of LiPF₆ and LFSI. These lithium salts may be used singly or in combination of two or more kinds

The non-aqueous electrolyte may further contain an additive other than the above. Examples of the additive include a cyclic carbonic ester having at least one carbon-carbon unsaturated bond (hereinafter, an unsaturated cyclic carbonic ester), and a cyclic carbonic ester having fluorine atom. The unsaturated cyclic carbonic ester and the cyclic carbonic ester having fluorine atom can contribute to the formation of a surface film with good quality on the LSX surface. It is to be noted that the sultone compound has a high reduction potential and, therefore, can form a surface film more preferentially than the additive. The additive may be added in an amount (mass ratio to the whole non-aqueous electrolyte) of, for example, 1 mass % or more and 10 mass % or less.

Examples of the unsaturated cyclic carbonic ester include vinylene carbonate (VC), vinylethylene carbonate, and divinylethylene carbonate. Examples of the cyclic carbonic ester having fluorine atom include fluoroethylene carbonate (FEC). These additives may be used singly or in combination of two or more kinds.

[Separator]

Usually, it is desirable to interpose a separator between the positive electrode and the negative electrode. The separator is excellent in ion permeability and has moderate mechanical strength and electrically insulating properties. The separator may be, for example, a microporous thin film, a woven fabric, or a nonwoven fabric. The separator is preferably made of, for example, polyolefin, such as polypropylene or polyethylene.

In an exemplary structure of the non-aqueous electrolyte secondary battery, an electrode group formed by winding the positive electrode and the negative electrode with the separator interposed therebetween is housed together with the non-aqueous electrolyte in an outer case. The wound-type electrode group may be replaced with a different form of the electrode group, for example, a stacked-type electrode group formed by stacking the positive electrode and the negative electrode with the separator interposed therebetween. The non-aqueous electrolyte secondary battery may be in any form, such as cylindrical type, prismatic type, coin type, button type, or laminate type.

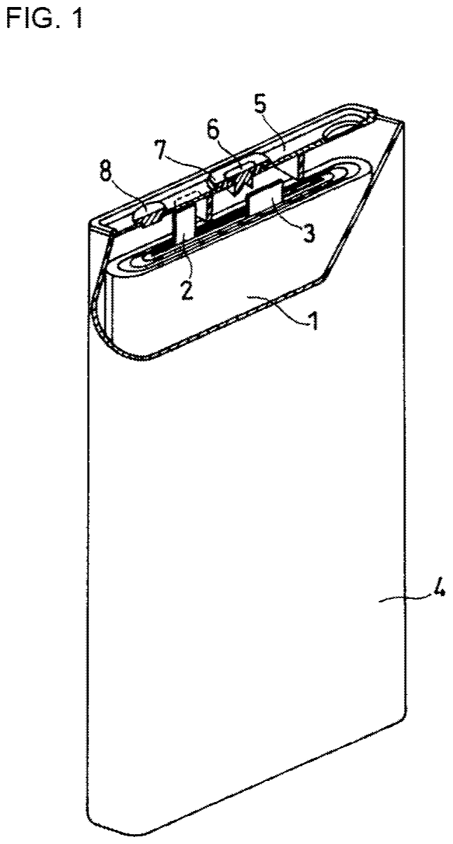

FIG. 1 is a partially cut-away schematic oblique view of a non-aqueous electrolyte secondary battery according to an embodiment of the present invention.

The battery includes a bottomed prismatic battery case 4, and an electrode group 1 and a non-aqueous electrolyte (not shown) housed in the battery case 4. The electrode group 1 has a long negative electrode, a long positive electrode, and a separator interposed therebetween and preventing them from directly contacting with each other. The electrode group 1 is formed by winding the negative electrode, the positive electrode, and the separator around a flat plate-like winding core, and then removing the winding core.

A negative electrode lead 3 is attached at its one end to the negative electrode current collector of the negative electrode, by means of welding or the like. The negative electrode lead 3 is electrically connected at its other end to a negative electrode terminal 6 disposed at a sealing plate 5, via a resin insulating plate (not shown). The negative electrode terminal 6 is electrically insulated from the sealing plate 5 by a resin gasket 7. A positive electrode lead 2 is attached at its one end to the positive electrode current collector of the positive electrode, by means of welding or the like. The positive electrode lead 2 is electrically connected at its other end, via the insulating plate, to the back side of the sealing plate 5. In other words, the positive electrode lead 2 is electrically connected to the battery case 4 serving as a positive electrode terminal. The insulating plate insulates the electrode group 1 from the sealing plate 5, and insulates the negative electrode lead 3 from the battery case 4. The sealing plate 5 is fitted at its periphery to the opening end of the battery case 4, and the fitted portion is laser-welded. In this way, the opening of the battery case 4 is sealed with the sealing plate 5. The electrolyte injection hole provided in the sealing plate 5 is closed with a sealing stopper 8.

The present invention will be specifically described below with reference to Examples and Comparative Examples. It is to be noted, however, the present invention is not limited to the following Examples.

### Example 1

[Preparation of Negative Electrode Material LSX]

Silicon dioxide and lithium carbonate were mixed so as to contain Si and Li in an atomic ratio: Si/Li of 1.05. The mixture was heated in the air at 950° C. for 10 hours, to obtain a lithium silicate represented by Li₂Si₂O₅ (z=0.5). The obtained lithium silicate was pulverized to have an average particle diameter of 10 μm.

The lithium silicate (Li₂Si₂O₅) having an average particle diameter of 10 μm was mixed with a raw material silicon (3N, average particle diameter: 10 μm) in a mass ratio of 40:60. The mixture was placed in a pot (made of SUS, volume: 500 mL) of a planetary ball mill (P-5, available from Fritsch Co., Ltd.), together with 24 SUS balls (diameter: 20 mm). In the pot with the lid closed, the mixture was pulverized at 200 rpm for 50 hours in an inert atmosphere.

Next, the powdered mixture was taken out from the pot in an inert atmosphere, which was then heated at 800° C. for four hours, in an inert atmosphere, with a predetermined pressure applied by a hot press, to give a sintered body of the mixture (a negative electrode material LSX).

Thereafter, the negative electrode material LSX was pulverized and passed through a 40-μm mesh, and then, the obtained LSX particles were mixed with a coal pitch (MCP 250, available from JFE Chemical Corporation). The mixture was fired at 800° C. in an inert atmosphere, to coat the LSX particles with an electrically conductive carbon, so that a conductive layer was formed on the particle surfaces. The amount of the conductive layer relative to the total mass of the LSX particles and the conductive layer was 5 mass %. Thereafter, a sieve was used to obtain LSX particles having the conductive layer and an average particle diameter of 5 μm.

The crystallite size of the silicon particles calculated by using the Scherrer formula from a diffraction peak attributed to the Si (111) plane obtained by XRD analysis of the LSX particles was 15 nm.

The composition of the lithium silicate phase was analyzed using the methods above (high-frequency induction heating furnace combustion and infrared absorption method, inert gas melting and non-dispersion type infrared absorption method, inductively coupled plasma emission spectroscopy (ICP-AES)). The result showed that the Si/Li ratio was 1.0, and the Li₂Si₂O₅ content measured by Si-NMR was 40 mass % (the silicon particle content was 60 mass %).

[Production of Negative Electrode]

The LSX particles having the conductive layer were mixed with graphite in a mass ratio of 5:95, and used as a negative electrode active material. The negative electrode active material was mixed with sodium carboxymethyl cellulose (CMC-Na) and styrene-butadiene rubber (SBR) in a mass ratio of 97.5:1:1.5, to which water was added. The mixture was stirred in a mixer (T.K. HIVIS MIX, available from PRIMIX Corporation), to prepare a negative electrode slurry.

Next, the negative electrode slurry was applied onto copper foil, so that the mass of a negative electrode material mixture per 1 m² of the copper foil was 190 g. The applied film was dried, and then rolled, to give a negative electrode with a negative electrode material mixture layer having a density of 1.5 g/cm³ formed on both sides of the copper foil.

[Production of Positive Electrode]

A lithium-nickel composite oxide (LiNi_{0.8}Co_{0.18}Al_{0.02}O₂) was mixed with acetylene black and polyvinylidene fluoride in a mass ratio of 95:2.5:2.5, to which N-methyl-2-pyrrolidone (NMP) was added. The mixture was stirred in a mixer (T.K. HIVIS MIX, available from PRIMIX Corporation), to prepare a positive electrode slurry. Next, the positive electrode slurry was applied onto aluminum foil. The applied film was dried, and then rolled, to give a positive electrode with a positive electrode material mixture layer having a density of 3.6 g/cm³ formed on both sides of the aluminum foil.

[Preparation of Non-Aqueous Electrolyte]

A lithium salt was dissolved in a non-aqueous solvent, to prepare a non-aqueous electrolyte. The non-aqueous solvent used here was prepared by adding a sultone compound, fluoroethylene carbonate (FEC), and vinylene carbonate (VC) to a mixed solvent containing ethylene carbonate (EC), dimethyl carbonate (DMC), and ethyl methyl carbonate (EMC). EC, DMC, and EMC were mixed in a volume ratio of 10:80:10. The content (mass ratio to the whole non-aqueous electrolyte) of the sultone compound in the non-aqueous electrolyte was set to 1 mass %. The sultone compound used here was 1,3-propene sultone (PRS). The content (mass ratio to the whole non-aqueous electrolyte) of the FEC in the non-aqueous electrolyte was set to 2 mass %. The content (mass ratio to the whole non-aqueous electrolyte) of the VC in the non-aqueous electrolyte was set to 2 mass %. The lithium salt used here was LiPF₆. The LiPF₆ concentration of in the non-aqueous electrolyte was set to 1.2 mol/L.

[Fabrication of Non-Aqueous Electrolyte Secondary Battery]

The positive electrode and the negative electrode, with a tab attached to each electrode, were wound spirally with a separator interposed therebetween such that the tab was positioned at the outermost layer, thereby to form an electrode group. The electrode group was inserted into an outer case made of aluminum laminated film and dried under vacuum at 105° C. for two hours. The non-aqueous electrolyte was injected into the case, and the opening of the outer case was sealed. A battery A1 was thus obtained.

### Example 2

In the preparation of negative electrode material LSX, the lithium silicate (Li₂Si₂O₅) having an average particle diameter of 10 μm was mixed with a raw material silicon (3N, average particle diameter: 10 μm) in a mass ratio of 45:55. In the resultant LSX particles having the conductive layer, the Li₂Si₂O₅ content measured by Si-NMR was 45 mass % (the silicon particle content was 55 mass %).

A battery A2 was fabricated in the same manner as in Example 1, except the above.

### Example 3

In the preparation of negative electrode material LSX, the lithium silicate (Li₂Si₂O₅) having an average particle diameter of 10 μm was mixed with a raw material silicon (3N, average particle diameter: 10 μm) in a mass ratio of 20:80. In the resultant LSX particles having the conductive layer, the Li₂Si₂O₅ content measured by Si-NMR was 20 mass % (the silicon particle content was 80 mass %).

A battery A3 was fabricated in the same manner as in Example 1, except the above.

### Example 4

A battery A4 was fabricated in the same manner as in Example 1, except that in the production of negative electrode, the LSX particles having the conductive layer were mixed with graphite in a mass ratio of 10:90, and used as a negative electrode active material.

### Example 5

A battery A5 was fabricated in the same manner as in Example 1, except that in the production of negative electrode, the LSX particles having the conductive layer were mixed with graphite in a mass ratio of 15:85, and used as a negative electrode active material.

### Example 6

A battery A6 was fabricated in the same manner as in Example 1, except that in the preparation of non-aqueous electrolyte, the PRS content in the non-aqueous electrolyte was set to 0.5 mass %.

### Example 7

In the preparation of non-aqueous electrolyte, LiPF₆ and LFSI were used as the lithium salt. The LiPF₆ concentration in the non-aqueous electrolyte was set to 1.0 mol/L. The LFSI concentration in the non-aqueous electrolyte was set to 0.2 mol/L.

A battery A7 was fabricated in the same manner as in Example 1, except the above.

### Example 8

In the preparation of non-aqueous electrolyte, LiPF₆ and LFSI were used as the lithium salt. The LiPF₆ concentration in the non-aqueous electrolyte was set to 0.6 mol/L. The LFSI concentration in the non-aqueous electrolyte was set to 0.6 mol/L.

A battery A8 was fabricated in the same manner as in Example 1, except the above.

### Example 9

In the preparation of negative electrode material LSX, the lithium silicate (Li₂Si₂O₅) having an average particle diameter of 10 μm was mixed with a raw material silicon (3N, average particle diameter: 10 μm) in a mass ratio of 45:55. In the resultant LSX particles having the conductive layer, the Li₂Si₂O₅ content measured by Si-NMR was 45 mass % (the silicon particle content was 55 mass %).

In the preparation of non-aqueous electrolyte, in place of the PRS, 1 mass % of 1,3-propane sultone (PS) was contained as the sultone compound in the non-aqueous electrolyte.

A battery A9 was fabricated in the same manner as in Example 1, except the above.

### Example 10

A battery A10 was fabricated in the same manner as in Example 1, except that in the preparation of non-aqueous electrolyte, the PRS content in the non-aqueous electrolyte was set to 2 mass %.

### Example 11

A battery A11 was fabricated in the same manner as in Example 1, except that in the preparation of non-aqueous electrolyte, the PRS content in the non-aqueous electrolyte was set to 0.1 mass %.

### Comparative Example 1

In the preparation of negative electrode material LSX, the lithium silicate (Li₂Si₂O₅) having an average particle diameter of 10 μm was mixed with a raw material silicon (3N, average particle diameter: 10 μm) in a mass ratio of 60:40. In the resultant LSX particles having the conductive layer, the Li₂Si₂O₅ content measured by Si-NMR was 60 mass % (the silicon particle content was 40 mass %).

A battery B1 was fabricated in the same manner as in Example 1, except the above.

### Comparative Example 2

In the preparation of negative electrode material LSX, the lithium silicate (Li₂Si₂O₅) having an average particle diameter of 10 μm was mixed with a raw material silicon (3N, average particle diameter: 10 μm) in a mass ratio of 10:90. In the resultant LSX particles having the conductive layer, the Li₂Si₂O₅ content measured by Si-NMR was 10 mass % (the silicon particle content was 90 mass %).

A battery B2 was fabricated in the same manner as in Example 1, except the above.

### Comparative Example 3

A battery B3 was fabricated in the same manner as in Example 1, except that in the preparation of non-aqueous electrolyte, no PRS was contained in the non-aqueous electrolyte.

### Comparative Example 4

In the preparation of negative electrode material LSX, the lithium silicate (Li₂Si₂O₅) having an average particle diameter of 10 μm was mixed with a raw material silicon (3N, average particle diameter: 10 μm) in a mass ratio of 45:55. In the resultant LSX particles having the conductive layer, the Li₂Si₂O₅ content measured by Si-NMR was 45 mass % (the silicon particle content was 55 mass %).

In the preparation of non-aqueous electrolyte, no PRS was contained in the non-aqueous electrolyte.

A battery B4 was fabricated in the same manner as in Example 1, except the above.

### Comparative Example 5

In the preparation of negative electrode material LSX, the lithium silicate (Li₂Si₂O₅) having an average particle diameter of 10 μm was mixed with a raw material silicon (3N, average particle diameter: 10 μm) in a mass ratio of 20:80. In the resultant LSX particles having the conductive layer, the Li₂Si₂O₅ content measured by Si-NMR was 20 mass % (the silicon particle content was 80 mass %).

In the preparation of non-aqueous electrolyte, no PRS was contained in the non-aqueous electrolyte.

A battery B5 was fabricated in the same manner as in Example 1, except the above.

### Comparative Example 6

In the preparation of non-aqueous electrolyte, the PRS content in the non-aqueous electrolyte was set to 2.1 mass %. Except this, a battery A11 was fabricated in the same manner as in Example 1.

A battery B6 was fabricated in the same manner as in Example 1, except the above.

### Comparative Example 7

In the production of negative electrode, in place of the LSX particles having the conductive layer, SiO particles (average particle diameter: 10 μm, x=1) was used. The SiO particles were mixed with graphite in a mass ratio of 5:95, and used as a negative electrode active material.

A battery B7 was fabricated in the same manner as in Example 1, except the above.

Each of the batteries fabricated above was evaluated by the following method.

[Evaluation 1: Initial Capacity]

With respect to the fabricated batteries, in a 25° C. environment, a constant-current charge was performed at a current of 0.3 It until the voltage reached 4.2 V, and then a constant-voltage charge was performed at a voltage of 4.2 V until the current reached 0.015 It. This was followed by a constant-current discharge at 0.3 It until the voltage reached 2.75 V. The rest time between charge and discharge was set to 10 minutes. The charge and discharge were performed in a 25° C. environment. A discharge capacity at this time was measured as an initial capacity. The results are shown in Table 1.

Here, (1/x)It represents a current, and (1/x)It (A)=Rated capacity (Ah)/X (h), where X represents the time consumed for charging or discharging electricity equivalent to the rated capacity. For example, 0.5 It represents a case where X=2 and means that the current value is the rated capacity (Ah)/2 (h).

[Evaluation 2: Cycle capacity retention ratio] A constant-current charge was performed at a current of 0.3 It until the voltage reached 4.2 V, and then, a constant-voltage charge was performed at a voltage of 4.2 V until the current reached 0.015 It. This was followed by a constant-current discharge at 0.3 It until the voltage reached 2.75 V. The rest time between charge and discharge was set to 10 minutes. The charge and discharge were performed in a 25° C. environment.

Charge and discharge was repeated under the charge and discharge conditions above. The ratio (percentage) of a discharge capacity at the 50th cycle to a discharge capacity at the 1st cycle was calculated as a cycle capacity retention ratio.

The evaluation results are shown in Table 1.

[Evaluation 3: Amount of Gas Generated During Battery Storage]

Under the same conditions as in the Evaluation 1, five cycles of charge and discharge was performed, and then charge was performed under the same conditions as in the Evaluation 1. The resultant charged battery was stored in an 80° C. environment for three days, to check the amount of gas generated within the battery during storage. The evaluation results are shown in Table 1.

TABLE 1

| | | | | | | | | | | Evaluation | | |
|---|---|---|---|---|---|---|---|---|---|---|---|---|
| | | | | | | | | | | | | Amount |
| | | Negative electrode | | | | | | | | | | of gas |
| | | | | Si | | Non-aqueous electrolyte | | | | | | generated |
| | | | | particle | | | Sultone | LiPF₆ | LFSI | | Cycle | during |
| | | Graphite | LSX | content | SiO | Kind of | compound | concen- | concen- | Initial | capacity | battery |
| | Battery | content | content | in LSX | content | sultone | content | tration | tration | capacity | retention | storage |
| | No. | (mass %) | (mass %) | (mass %) | (mass %) | compound | (mass %) | (mol/L) | (mol/L) | (mAh) | ratio (%) | (cc/Ah) |
| Ex. 1 | A1 | 95 | 5 | 60 | — | PRS | 1 | 1.2 | — | 3445 | 96 | 21 |
| Ex. 2 | A2 | 95 | 5 | 55 | — | PRS | 1 | 1.2 | — | 3403 | 97 | 20 |
| Ex. 3 | A3 | 95 | 5 | 80 | — | PRS | 1 | 1.2 | — | 3522 | 95 | 22 |
| Ex. 4 | A4 | 90 | 10 | 60 | — | PRS | 1 | 1.2 | — | 3461 | 94 | 22 |
| Ex. 5 | A5 | 85 | 15 | 60 | — | PRS | 1 | 1.2 | — | 3472 | 94 | 22 |
| Ex. 6 | A6 | 95 | 5 | 60 | — | PRS | 0.5 | 1.2 | — | 3447 | 96 | 21 |
| Ex. 7 | A7 | 95 | 5 | 60 | — | PRS | 1 | 1.0 | 0.2 | 3449 | 97 | 21 |
| Ex. 8 | A8 | 95 | 5 | 60 | — | PRS | 1 | 0.6 | 0.6 | 3457 | 98 | 20 |
| Ex. 9 | A9 | 95 | 5 | 55 | — | PS | 1 | 1.2 | — | 3401 | 92 | 24 |
| Ex. 10 | A10 | 95 | 5 | 60 | — | PRS | 2 | 1.2 | — | 3443 | 93 | 20 |
| Ex. 11 | A11 | 95 | 5 | 60 | — | PRS | 0.1 | 1.2 | — | 3442 | 91 | 25 |
| Com. Ex. 1 | B1 | 95 | 5 | 40 | — | PRS | 1 | 1.2 | — | 3109 | 98 | 25 |
| Com. Ex. 2 | B2 | 95 | 5 | 90 | — | PRS | 1 | 1.2 | — | 3552 | 78 | 40 |
| Com. Ex. 3 | B3 | 95 | 5 | 60 | — | — | — | 1.2 | — | 3440 | 88 | 34 |
| Com. Ex. 4 | B4 | 95 | 5 | 55 | — | — | — | 1.2 | — | 3402 | 89 | 32 |
| Com. Ex. 5 | B5 | 95 | 5 | 80 | — | — | — | 1.2 | — | 3517 | 87 | 35 |
| Com. Ex. 6 | B6 | 95 | 5 | 60 | — | PRS | 2.1 | 1.2 | — | 3441 | 79 | 23 |
| Com. Ex. 7 | B7 | 95 | — | — | 5 | PRS | 1 | 1.2 | — | 3002 | 79 | 35 |

In the batteries A1 to A11, a surface film derived from PRS was moderately formed on the surfaces of the LSX particles, which resulted in a high cycle capacity retention ratio and a small amount of gas generated during battery storage.

With respect to another battery A1, one cycle of charge and discharge was performed under the same conditions as in the Evaluation 1, and then, charge was performed under the same conditions as in the Evaluation 1. The resultant charged battery A1 was disassembled, to check the components of its non-aqueous electrolyte by gas chromatography mass spectrometry. The result found that the amount of the remaining PRS in the battery A1 was 50 ppm.

In the battery B1, the non-aqueous electrolyte having a PRS content of 1 mass % was used, but the silicon particle content in the LSX particles was as small as 40 mass %, which resulted in a low initial capacity.

In the battery B2, the non-aqueous electrolyte having a PRS content of 1 mass % was used. However, the silicon particle content in the LSX particles was as large as 90 mass %, because of which the LSX particles expanded and contracted greatly during charge and discharge, and the surface film failed to follow the expansion and contraction of the LSX particles and was broken. This resulted in a low cycle capacity retention ratio and a large amount of gas generated during battery storage.

In the batteries B3 to B5, the silicon particle content in the LSX particles was 55 mass % or more and 80 mass % or less. However, the non-aqueous electrolyte containing no PRS was used, and therefore, the surface film was broken, which resulted in a low cycle capacity retention ratio and a large amount of gas generated during battery storage.

In the battery B6, the silicon particle content in the LSX particles was 60 mass %. However, the non-aqueous electrolyte having a PRS content as high as exceeding 2 mass % was used, because of which a surface film derived from PRS was formed excessively on the LSX particles, and the reaction resistance was increased. This resulted in a low cycle capacity retention ratio.

In the battery B7, the non-aqueous electrolyte having a PRS content of 1 mass %. However, SiO particles were used in place of the LSX particles having a silicon content exceeding 40 mass %, which resulted in a low initial capacity. Since the SiO₂ phase in the SiO particles was neutral, a surface film derived from PRS was not densely and uniformly formed on the SiO particles, and the surface film failed to have sufficient durability. This resulted in a low cycle capacity retention ratio and a large amount of gas generated during battery storage. Furthermore, since the irreversible capacity of the SiO particles was larger than that of the LSX particles, the cycle capacity retention ratio was lowered.

### INDUSTRIAL APPLICABILITY

The non-aqueous electrolyte secondary battery according to the present invention is useful as a main power source for mobile communication equipment, portable electronic equipment, and other devices.

### REFERENCE SIGNS LIST

1: electrode group
2: positive electrode lead
3: negative electrode lead
4: battery case
5: sealing plate
6: negative electrode terminal
7: gasket
8: sealing stopper

1. A non-aqueous electrolyte secondary battery, comprising:
a positive electrode; a negative electrode; and a non-aqueous electrolyte, wherein
the negative electrode includes a negative electrode active material capable of electrochemically absorbing and releasing lithium,
the negative electrode active material includes a composite material containing a silicate phase and silicon particles dispersed in the silicate phase,
the silicate phase includes at least one of an alkali metal and an alkaline earth metal,
a content of the silicon particles in the composite material is above 40 mass % and 80 mass % or less,
the non-aqueous electrolyte includes a sultone compound, and
a content of the sultone compound in the non-aqueous electrolyte is 2 mass % or less.

2. The non-aqueous electrolyte secondary battery according to claim 1, wherein the content of the sultone compound in the non-aqueous electrolyte is 0.1 mass % or more and 2 mass % or less.

3. The non-aqueous electrolyte secondary battery according to claim 1, wherein
the silicate phase is an oxide phase containing lithium, silicon, and oxygen, and
an atomic ratio: O/Si of the oxygen to the silicon in the silicate phase is above two and below four.

4. The non-aqueous electrolyte secondary battery according to claim 3, wherein the silicate phase has a composition represented by a formula: Li_{2z}SiO_{2+z}, and
z in the formula satisfies 0<z<2.

5. The non-aqueous electrolyte secondary battery according to claim 1, wherein the content of the silicon particles in the composite material is 55 mass % or more and 80 mass % or less.

6. The non-aqueous electrolyte secondary battery according to claim 1, wherein the sultone compound includes 1,3-propene sultone.

7. The non-aqueous electrolyte secondary battery according to claim 1, wherein
the non-aqueous electrolyte contains a non-aqueous solvent and a lithium salt dissolved in the non-aqueous solvent, and
the lithium salt includes at least one of LiN(SO₂F)₂ and LiPF₆.
